(19) United States
(12) Patent Application Publication
(10) Pub. No.: US 2005/0018865 A1
(43) Pub. Date: Jan. 27, 2005

(54) Loudspeaker

(76) Inventors: Henry Azima, Cambridgeshire (GB); Nicholas P.R. Hill, Cambridgeshire (GB); Julian Fordham, Cambridgeshire (GB)

Correspondence Address: FOLEY AND LARDNER;SUITE 500, 3000 K STREET NW, WASHINGTON, DC, 20007, US

(21) Appl. No.: 10/491,631

(22) PCT Filed: Sep. 30, 2002
(86) PCT No.: PCT/GB02/04399

(30) Foreign Application Priority Data
Oct. 5, 2001 (GB) 0123932.6

(51) Int. Cl. H04R 25/00

(52) U.S. Cl. 381/190

(57) ABSTRACT

A resonant bending wave loudspeaker comprising a panel-form acoustic radiator in the form of a beam and a vibration transducer mounted to the beam at a position to apply bending wave energy thereto to enable low frequency modes to be excited in the radiator both lengthwise of the radiator and crosswise of the radiator, and means mounting the radiator to permit the excitation of low frequency lengthwise and crosswise modes therein. From another aspect, the invention is a method of designing a resonant bending wave loudspeaker of the kind described above, comprising determining a position for locating the vibration transducer on the beam by deriving a model of the resonant modes in the beam from physical parameters of the beam, using the model to calculate the mechanical input power from the transducer to the beam as a function of frequency, calculating a measure of smoothness of the mechanical input power and selecting the position of the vibration transducer which has a desired value of the measure of smoothness.

### TECHNICAL FIELD

This invention relates to panel loudspeakers, in particular loudspeakers which rely on the generation of bending waves in order to produce an acoustic response.

### BACKGROUND ART

Distributed mode loudspeakers (DMLs) are described in International patent application No. WO97/09842 and rely upon producing resonant bending wave modes in a panel or plate. Distributed mode loudspeakers exhibit wide directivity and can generate an acoustic response from 50 Hz to 20 kHz. WO97/09842 teaches preferred embodiments of panels or plates which possess aspect ratios (Lx/Ly) of 1.13:1 and 1.41:1 for isotropic materials which produce a high density of modes in the low frequency region of the loudspeaker.

The lowest frequency (f₀) along one of the orthogonal axes of a rectangular panel can be expressed according to equation 1 below in terms of the bending stiffness or rigidity (B) in the specific direction and the length of the panel in that same direction (This assumes an isotropic material with uniform thickness and a homogeneous panel.):

$${( {f}_{0} )}^{2} ∝ \frac{B}{{l}^{4}} \qquad Equation ( 1 )$$

where f₀: fundamental frequency (Hz)
B : bending stiffness (Nm)
l: length of panel

Equation 1 predicts the fundamental or lowest frequency in the two directions for a panel or plate but the higher modal frequencies can also be predicted for a particular panel or plate. All plates or panels exhibit a number of bending or flexural modes, each of which operates at a specific frequency and shows a corresponding unique mode shape. The frequency at which the modes occurs can be predicted by consideration of the eigenvalues for the system via the physical dimensions, panel mechanical properties and boundary conditions for the system.

As an example of a plate designed according to WO97/09842, Table 1 shows the modal frequencies for a plate of size 150 mm×131 mm made from a material known as Acoustic 88-2 mm made by Euro Composites S.A. (anisotropy ratio of 1.2) in the free-free case. The properties of Acoustic 88-2 mm are listed in Table 2.

TABLE 1
Modal Frequencies for Plate 150 mm × 131 mm in Free-Free Case

| | 0 | 1 | 2 | 3 | 4 | 5 | 6 | 7 | 8 |
|---|---|---|---|---|---|---|---|---|---|
| 0 | 0 | 0 | 427 | 1177 | 2307 | 3813 | 5696 | 7955 | 10591 |
| 1 | 0 | 272 | 698 | 1434 | 2544 | 4036 | 5909 | 8161 | 10792 |
| 2 | 510 | 752 | 1304 | 2101 | 3214 | 4694 | 6551 | 8789 | 11408 |
| 3 | 1407 | 1628 | 2220 | 3075 | 4213 | 5696 | 7545 | 9770 | 12374 |
| 4 | 2758 | 2959 | 3540 | 4409 | 5555 | 7033 | 8868 | 11076 | 13661 |
| 5 | 4558 | 4747 | 5310 | 6172 | 7309 | 8772 | 10584 | 12765 | 15323 |
| 6 | 6809 | 6989 | 7535 | 8382 | 9502 | 10942 | 12724 | 14870 | 17391 |
| 7 | 9511 | 9684 | 10215 | 11046 | 12147 | 13560 | 15309 | 17414 | 19891 |
| 8 | 12662 | 12830 | 13350 | 14166 | 15248 | 16635 | 18349 | 20412 | 22841 |

TABLE 2
Panel Material Properties

| | | | | Bending |
|---|---|---|---|---|
| | | | Bending | Rigidity in |
| | | Areal | Rigidity in | y- |
| Panel | | Weight | x-direction, | direction, |
| Designation | Panel Description | (kg m⁻²) | Bx (Nm) | By (Nm) |
| Acoustic | Impregnated paper | 0.403 | 3.42 | 2.84 |
| 88-2 mm | skins on paper | | | |
| | honeycomb core | | | |
| | material 2 mm thick | | | |

In terms of the notation used to describe a specific mode shape which is used in Table 1, the notation used considers the nodal lines for a particular mode. A nodal line is that part of the mode which shows no displacement for that specific frequency. For the notation of a particular mode shape, the number of nodal lines crossing a specific axis are counted for two orthogonal axes for the panel.

From Table 1, it is clear that the frequency response of the panel will be dominated by modes produced in both directions of the panel. For example, below 1 kHz, the following modes will be excited: (1,1), (2,0), (0,2), (2,1), (1,2)

For this system, the modes in both directions make an approximately equal contribution to the ‘modal fill’ or mode distribution at frequencies less than 1 kHz. Via the use of aspect ratio or other physical panel parameter, it is possible to design a panel which can have a dense modal structure at low frequencies but it is also desirable that all of these modes are promoted in the panel via the means of excitation. Thus the position of the exciting force is critical in determining which modes will be excited. The position of the exciter should preferably be such that most or all the low frequency modes required are promoted.

For any aspect ratio of panel, a set of modal frequencies can be predicted by analysis. For a distributed mode loudspeaker designed according to WO97/09842, the modal frequencies over a specific frequency range may be calculated and thus interleaved by adjusting the aspect ratio of the panel whilst also considering the mechanical properties of the panel. Generally, the high frequency performance of a DML does not require the same degree of modal interleaving because the number of high frequency modes is far greater than at low frequencies. Therefore the lower frequency modal frequencies are considered when designing for a modal density of a panel over a desired range.

For an isotropic material, of a range of options two aspect ratios are discussed in WO97/09842 (1.13:1 & 1.41:1) and can be used to obtain a good modal distribution at low frequencies. However if the panel stiffnesses in the two directions x and y are different (referred to as Bx and By), the modal frequencies will clearly be affected. In order to produce a good modal distribution, a new set of aspect ratios should be considered for such a material which are also described in WO97/09842.

For many DML products, space restrictions and aesthetic requirements may dictate that beam-like high aspect ratio panels are useful. For example, for TV applications, the limited space available in the front frame of the TV indicates that for maximum bandwidth and modal density, an elongate or high aspect ratio panel is required.

As the aspect ratio increases, the relationship of the modes in the system change in frequency compared to those for a simple rectangular plate and the distribution tends to be dominated by modes in the longer dimension. Table 3 shows the modal frequencies for a panel of the same area as that in Table 1 but with an aspect ratio of 50:1 and using a material which is highly anisotropic and in which the stiff direction is placed across the beam width.

TABLE 3
Modal Frequencies for Plate 990 mm × 20 mm in
Free-Free Case with Stiffer direction across Beam Width

| | 0 | 1 | 2 | 3 | 4 | 5 | 6 | 7 | 8 | 9 | 10 |
|---|---|---|---|---|---|---|---|---|---|---|---|
| 0 | 0 | 0 | 5 | 13 | 25 | 42 | 62 | 87 | 116 | 149 | 186 |
| 1 | 0 | 1681 | 3414 | 5065 | 6635 | 8189 | 9734 | 11274 | 12810 | 14343 | 15876 |
| 2 | 82605 | 82676 | 82895 | 83243 | 83696 | 84262 | 84937 | 85718 | 86603 | 87589 | 88672 |

In the description we have chosen to use the term “torsional modes” for those cross modes that are not orthogonal to the long axis.

From Table 3 it is clear that the (0,n) length modes dominate the low frequency performance. This is the case for the invention described in WO00/78090. The (1,n) or torsional modes commence at a frequency of 1.68 kHz whilst the (2,n) modes which are the orthogonal, width or transverse modes have a lowest frequency of 82.6 kHz. Neither of these latter sets of modes contributes to the low frequency performance of this beam and therefore, are not important in determining the optimal exciter position. By specifically promoting modes in one direction, an acoustic device is produced which shows unique characteristics.

### DISCLOSURE OF INVENTION

The present invention provides a resonant bending wave loudspeaker comprising a beam-like panel-form acoustic radiator and a transducer mounted to the radiator at a position on the radiator to enable low frequency modes to be excited in the radiator both lengthwise of the radiator and crosswise of the radiator, and means mounting the radiator to permit the excitation of low frequency lengthwise and crosswise modes therein.

The beam may have an aspect ratio of at least 5:1 and less than 50:1.

The beam may be of a material with an anisotropy of bending stiffness ratio in the x and y directions of between 5:1 to 1:5.

The physical parameters of the beam and the position of the transducer on the beam may be such that the lengthwise and crosswise modes in the beam are interleaved in frequency to create a smooth low frequency response.

The mounting means may restrain the short edges of the beam. The mounting means may be attached to the beam in regions where it has minimal effect upon the modal distribution of the radiator.

The driving position of the or each vibration transducer may be contained within the regions defined as ‘Level 1’ and ‘Level 2’ as shown in FIGS. 5 to 16.

The mounting means may provide non-symmetrical edge or boundary conditions for the opposing sides of the beam.

The mounting means may comprise a suspension of compliant tape/film or a soft low modulus foam applied to the long dimensions of the beam to damp the low frequency modes to smooth the frequency response.

The beam may have an aspect ratio and mechanical properties such that its mechanical impedance increases as a function of the root of frequency.

The vibration transducer may be electrodynamic and the mechanical impedance of the beam at low frequencies may interact with the exciter parameters, thereby creating a loudspeaker where the frequency of the modes in the low frequency region is altered by the presence of the exciter.

From another aspect the invention is a method of designing a resonant bending wave loudspeaker of the kind described above, comprising determining a position for locating the vibration transducer on the beam by deriving a model of the resonant modes in the beam from physical parameters of the beam, using the model to calculate the mechanical input power from the transducer to the beam as a function of frequency, calculating a measure of smoothness of the mechanical input power and selecting the position of the vibration transducer which has a desired value of the measure of smoothness.

The measure of smoothness of the mechanical input power may be a measure of the mean square deviation of the input power from a constant value for the average input power. The constant value may be a straight (i.e. horizontal) line fit to the average input power with any trend (e.g. increase with frequency) removed. Thus there is no variation in frequency for the constant value. The mechanical input power may be calculated when applying a constant point force to a single point on the beam.

### BRIEF DESCRIPTION OF DRAWINGS

The invention is diagrammatically illustrated, by way of example, in the accompanying drawings, in which:

FIG. 1 is a nodal line map for a beam-like high aspect ratio DM panel;

FIG. 2 is a drivemap quadrant for a panel with an aspect ratio in the range 18:1 to 50:1;

FIG. 3 is a drivemap quadrant for a panel with an aspect ratio in the range 12:1 to 18:1;

FIG. 4 is a drivemap quadrant for a panel with an aspect ratio in the range 7:1 to 12:1;

FIG. 5 is a drivemap quadrant for a panel with an aspect ratio in the range 5:1 to 7:1;

FIG. 6 is a drivemap quadrant for a panel with an aspect ratio in the range 18:1 to 50:1 and with simply supported short edges and free long edges;

FIG. 7 is a drivemap quadrant for a panel with an aspect ratio in the range 12:1 to 18:1 and with simply supported short edges and free long edges;

FIG. 8 is a drivemap quadrant for a panel with an aspect ratio in the range 7:1 to 12:1 and with simply supported short edges and free long edges;

FIG. 9 is a drivemap quadrant for a panel with an aspect ratio in the range 5:1 to 7:1 and with simply supported short edges and free long edges;

FIG. 10 is a drivemap quadrant for a panel with an aspect ratio in the range 18:1 to 50:1 and with clamped short edges and free long edges;

FIG. 11 is a drivemap quadrant for a panel with an aspect ratio in the range 12:1 to 18:1 and with clamped short edges and free long edges;

FIG. 12 is a drivemap quadrant for a panel with an aspect ratio in the range 7:1 to 12:1 and with clamped short edges and free long edges;

FIG. 13 is a drivemap quadrant for a panel with an aspect ratio in the range 5:1 to 7:1 and with clamped short edges and free long edges;

FIG. 14 is a graph of measured beam impedance vs. theoretical beam impedance;

FIG. 15 is a graph of key exciter parameters vs. measured beam impedance;

FIG. 16 is a graph of simulated on-axis acoustic pressure vs. frequency;

FIG. 17a is a graph of simulated drivepoint velocity vs. frequency;

FIG. 17b is a graph of simulated drivepoint velocity vs. frequency.

FIG. 18 is a diagram of a panel showing different exciter positions;

FIG. 19 is a graph of drivepoint velocity vs. frequency;

FIG. 20 is a plan view of a first embodiment of loudspeaker;

FIG. 21 is a graph of on-axis acoustic pressure of the loudspeaker of FIG. 20 with the exciter in two different positions;

FIG. 22 is a plan view of a second embodiment of loudspeaker;

FIG. 23 is a graph of on-axis acoustic pressure of the loudspeaker of FIG. 22 with the exciter in two different positions;

FIG. 24 is a plan view of a third embodiment of loudspeaker;

FIG. 25 is a graph of on-axis acoustic pressure of the loudspeaker of FIG. 24 in two different conditions;

FIG. 26 is a plan view of a fourth embodiment of loudspeaker;

FIG. 27 is a graph of on-axis acoustic pressure of the loudspeaker of FIG. 24 in two different positions;

FIG. 28 is a front view of a display screen or monitor with beam-like panel speakers on opposite sides of the screen;

FIG. 29 is a rear view of the speaker panel for the embodiment of FIG. 38;

FIG. 30 is a graph of spatially averaged sound pressure level against frequency for the speaker of FIGS. 28 and 29, and

FIG. 31 is a graph of response of the speaker of FIGS. 28 to 30 with an added low frequency speaker.

### Best Modes for Carrying out the Invention

The present invention applies to a range of high aspect ratio panels which can be used as Distributed Mode Loudspeakers. There are several characteristics of beams which need to be considered when designing a loudspeaker using such high aspect ratios. The invention has three aspects as listed below, which will each be described in turn:
1. Excitation of Beam Modes via Exciter Position and Aspect Ratio
2.Effect of Suspension on Beam Acoustic Performance
3.Interaction between Exciter and Beam

Following a general description of these features, a number of embodiments will then be considered which exhibit these features.

1. Excitation of Beam Modes via Exciter Position and Aspect Ratio

One element of the present invention is the use of exciter and suspension positions to control the acoustic output of a high aspect ratio loudspeaker system. For an isotropic panel with aspect ratio of approximately 12:1, the modal frequencies are as shown in Table 4:

TABLE 4
Modal Frequencies for Plate 490 mm x 40 mm in
Free-Free Case for Acoustic 88-2 mm

| Mode | | | | | | | | | | | | |
|---|---|---|---|---|---|---|---|---|---|---|---|---|
| No. | 0 | 1 | 2 | 3 | 4 | 5 | 6 | 7 | 8 | 9 | 10 | 11 |
| 0 | 0 | 0 | 40 | 110 | 216 | 357 | 534 | 745 | 992 | 1275 | 1592 | 1945 |
| 1 | 0 | 273 | 555 | 829 | 1097 | 1375 | 1666 | 1974 | 2302 | 2652 | 3027 | 3428 |
| 2 | 5473 | 5501 | 5588 | 5723 | 5897 | 6112 | 6365 | 6655 | 6981 | 7341 | 7734 | 8160 |

| Mode | | | | | | | | | | | |
|---|---|---|---|---|---|---|---|---|---|---|---|
| No. | 12 | 13 | 14 | 15 | 16 | 17 | 18 | 19 | 20 | 21 | 22 |
| 0 | 2333 | 2757 | 3216 | 3710 | 4239 | 4804 | 5404 | 6039 | 6709 | 7415 | 8156 |
| 1 | 3856 | 4314 | 4802 | 5321 | 5871 | 6453 | 7068 | 7717 | 8399 | 9114 | 9864 |
| 2 | 8618 | 9108 | 9630 | 10183 | 10768 | 11384 | 12033 | 12712 | 13424 | 14169 | 14945 |

From Table 4, it is clear that most of the low frequency modes are the (0,n) and (1,n) set of frequencies. It is therefore, important to interleave these two sets of modes in order to obtain the optimum modal density at low frequency for this system. The first (2,n) orthogonal, transverse mode occurs at 5.5 kHz and is therefore not relevant to positioning the exciter in order to promote low frequency modes.

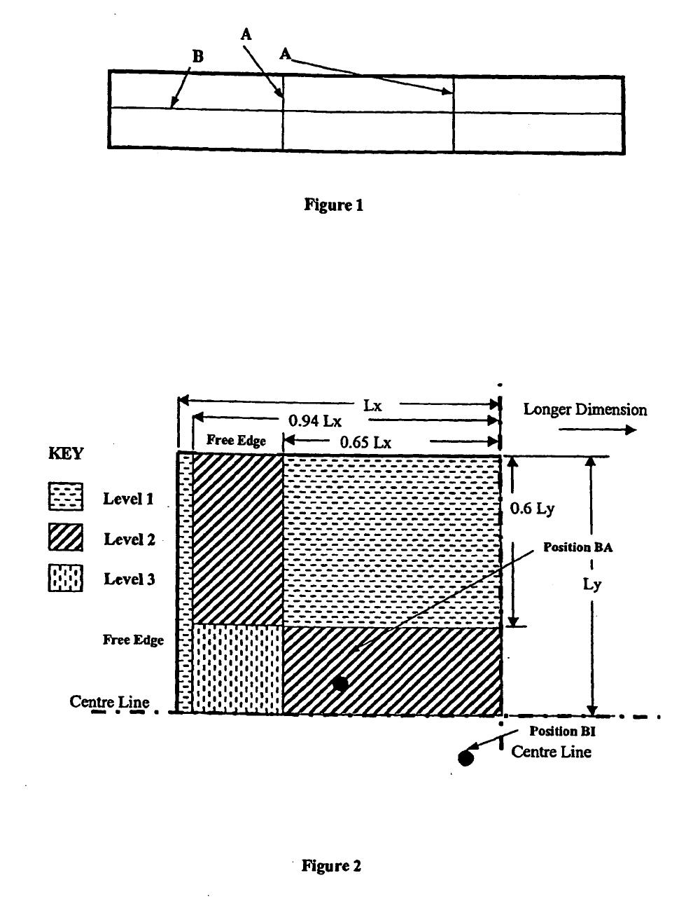

In order to excite the useful modal frequencies, both (0,n) and (1,n) in this beam, it is important to position the exciter accordingly. For the (1,2) mode, the basic mode shape is as shown in FIG. 1 and comprises node lines A parallel to the shorter beam dimension and positioned one third and two thirds along the beam and a node line B extending along the beam on its long axis. In order to promote this specific mode in a high aspect ratio panel, the exciter should be positioned away from the nodal lines. The nodal line B shown above is common for all (1,n) modes in the panel and therefore the exciter should be positioned away, e.g. at A, from this line in order to promote these modes. The nodal lines for the (0,n) set of modes are all parallel to the shorter dimension and these should also be taken into account when positioning the exciter.

Therefore, as a general rule, for any panel with aspect ratio between from 5:1 up to approx. 50:1, the (1,n) modes should be excited and interleaved with the (0,n) modes in order to produce the optimal modal density and hence smoothest low frequency response for that system. The preferred locations of the exciter will be different to examples specified in WO97/09842 e.g. 4/9, 3/7, etc. The present invention applies to a range of material types. The use of these torsional cross-modes at low frequencies to interleave with the (0,n) length modes is also different to the prior art approach.

As the aspect ratio increases, the preferred exciter positions will tend to be located further away from the longitudinal axis.

For any system, the input power for a panel or beam can be calculated from the physical dimensions, boundary conditions and mechanical properties of the panel over a specific frequency range. By using statistical analysis on the modal frequencies, it is possible to produce a drivemap (similar to nodal line maps) which can give a picture of the drive positions. These maps can be termed ‘smoothness’ drivemaps.

In summary, the method to determine the exciter position on the panel is a systematic assessment of performance of the object with exciter location. In detail, an analytical model of the system is set up as a superposition of the natural modes of the high aspect ratio panel. This is done on the basis of the geometry of the panel and its composition. This model is then used to calculate the mechanical input power as a function of frequency, when a constant point force is applied at a single point. An optimisation function that gives a measure of smoothness of this function is then calculated from the mean square deviation from a straight line fit to the input power as a function of frequency. The best drive points are then found from an optimisation for smoothness of input power as a function of frequency.

The drive maps presented above represent the results of the above optimisation procedure, grouped into ranges of aspect ratio. The areas outlined in the maps have been shown as 3 regions of increasing smoothness, which are generally characteristic of the behaviour over the corresponding aspect ratio range.

Here they are separated into three separate levels as listed in Table 5. FIGS. 2 to 5 show a set of drivemaps where these regions have been specified for a range of aspect ratios. Each level gives a relative degree of interleaving scaled for that particular system. These drivemaps, not to scale, only show one quarter of the panel because the boundary conditions are symmetrical in the two orthogonal axes of the panel.

TABLE 5
Optimization Levels for Regions of Panel for
Exciter Positioning

| Level | Description |
|---|---|
| 1 | High degree of interleaving of |
| | modes |
| 2 | Intermediate level of interleaving |
| 3 | Low level of interleaving |

For some applications, the ‘Level 1’ interleaving positions may be less relevant because the designer may chose a more dominant excitation of a specific mode or modes in the beam. It is important to note that the objective of a high degree of interleaving is different from promoting the lowest possible frequency in the beam. For some applications this may be a more important requirement and the designer may chose the parameters for a specific balance with respect to interleaving and bandwidth.

As mentioned previously, most loudspeaker systems require some form of mechanical support for the panel so that the panel is fixed and stable in its frame. It is also important to ensure that the vibrations or modes in the panel are not significantly transmitted to the frame where they can cause unwanted vibrations and sounds. Soft foams or high compliance materials are often used for this purpose as they are effective at absorbing these vibrations and also do not add much mass or extra stiffness to the loudspeaker system. However, it is useful to take into consideration the effect of the suspension and its locations to ensure that the effect on the modal distribution of the panel is benign or even beneficial. The drivemaps used to locate the optimal position for placing an exciter can also be used to assist in finding a suitable location for the suspension or mounting material. The good positions for supports are at the nodal lines for the specific frequency range of interest. For all the drivemaps (FIGS. 2 to 5), Level 3 regions are thus the preferred positions for suspensions/mountings in order to control the interaction with the modal frequencies of the system.

In this section a number of drivemaps will be considered which are valid for a range of aspect ratios. Clearly, the aspect ratio will have a significant effect upon the optimal drive positions and so a number of general drivemaps have been produced which cover aspect ratios from 5:1 to 35:1. It should be noted that the regions on these drivemaps are subject to a ±10% tolerance for the exciter coordinates. This is because these drivemaps are applicable to a range of aspect ratios. As discussed in section 1, the anisotropy ratio of the panel can have a significant effect upon the modes in the panel and hence the optimal exciter positions. Therefore, a consideration of the anisotropy is important when showing drivemaps. For all the drivemaps (FIGS. 2 to 5) in this section, they are shown for anisotropies of up to 7:1 in either direction.

In a specific panel, a designer may analyse for a specific drivemap based on the chosen parameters.

FIG. 2 shows one of these general drivemaps where the regions have been divided up as given in Table 5 for a free-free panels of aspect ratios in the range 18:1 to 50:1 made from Acoustic 88-2 mm and with free-free edge conditions. FIG. 2 only applies for one quadrant of a panel as this is all that is required to show the result for a beam with the same boundary conditions on all sides. Clearly, as discussed earlier, the good positions (Level 1) are seen to be towards the long edges of the panel and also the short edges. In practical terms, the region next to the short edges is more difficult to drive as it is a narrow area to fit an exciter of finite size. Thus the larger area adjacent to the long edge would be preferred for most practical solutions.

The cases for a range of different aspect ratios will now also be considered

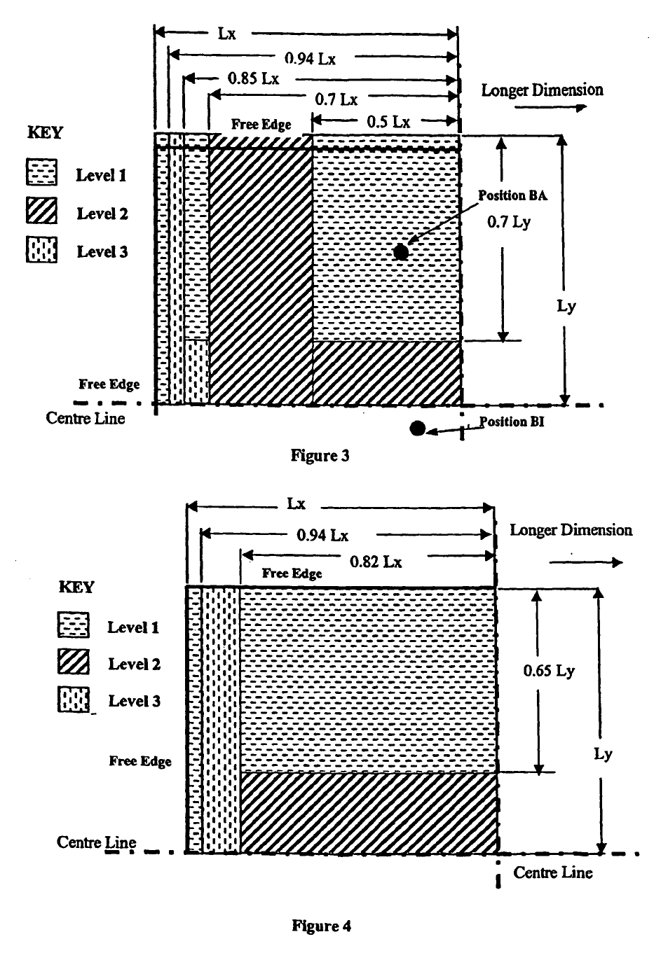

FIG. 3 shows a generalized drivemap for panel aspect ratios from 12:1≧AR<18:1 in the free-free condition, which show a number of different optimal drive positions. As with FIG. 2, the Level 1 area next to the short edge is not a practical solution. Two separate ‘Level 1’ regions are now present and an extended ‘Level 3’ area is now showing.

FIG. 4 shows another drivemap for panel aspect ratios from 7:1≧AR<12:1 in the free-free condition, which shows many similarities compared to FIG. 3. The ‘Level 1’ region extends across a larger proportion of the panel compared to FIG. 3 but there is also a larger ‘Level 3’ region.

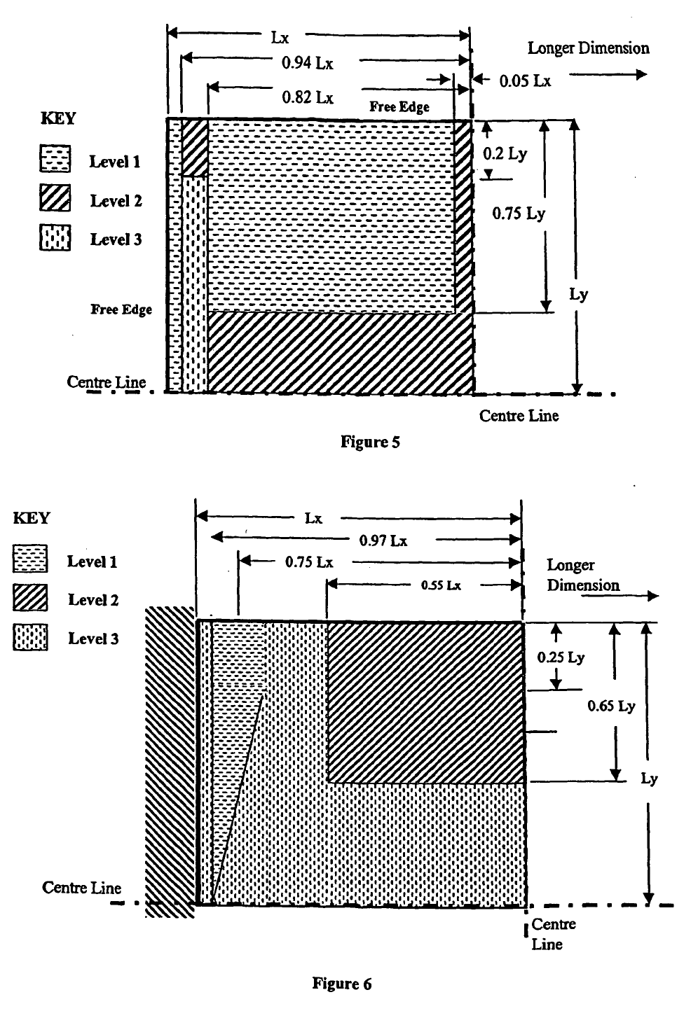

FIG. 5 is a drivemap which shows the case for panel aspect ratios from 5:1≧AR<7:1 in the free-free condition. The mid-point of the long dimension of the panel has become less useful when compared to higher aspect ratios (downgraded from Level 1 to Level 2).

For all the drivemaps (FIGS. 2 to 5), a common feature is that the central axis for the long dimension of the beam is not an optimal drive position (i.e. ‘Level 1’) and the preferred suspension positions are towards the ends of the long dimension. The optimal or ‘Level 1’ drive positions tend to be situated towards the long edges of the beams. This supports the fact that the (1,n) modes need to be considered when optimising the interleaving of modes at low frequency.

2. Effect of Suspensions on Beam Acoustic Performance

Section 1 dealt with using drivemaps to position the exciter and suspension positions such that the available modal density are optimised for a free panel. However, in practice most applications using very high aspect ratio panels will involve boundary conditions to support the panel and also a form of baffle to isolate the front panel radiation from the rear radiation i.e. to eliminate cancellation problems and the associated low frequency roll-off.

Therefore, in this section, some of the effects of boundary conditions on the mechanical properties (modal frequencies) and acoustic performance will be covered. Firstly a broad description of the various types of boundary condition and their effect on the mechanical/acoustic panel properties is given.

Free Edge Boundary Conditions

Free edge conditions are those where no force is exerted on that edge and is not connected to any form of support. This condition leads to the lowest set of modes for a specific panel but as mentioned previously may not be practically possible due to the requirements to separate the front and rear radiation, and the requirement of providing support to the panel.

Clamped Boundary Conditions

Clamped edge conditions are those where no displacement or rotation of the beam occurs in any direction. In practical terms, a true clamped edge condition is very difficult to achieve particularly at high frequencies. By fixing the edges, the active vibrating area is limited to the central region of the panel.

Simply Supported Boundary Conditions

This edge condition is where no motion is possible but rotation is free. Again it is difficult to produce this edge condition in practise because any rotation at the panel edge is often accompanied by a perpendicular displacement of the panel.

Compliant Suspension Edge Conditions/Complex Impedance Edge Termination

Thin, compliant films or tapes of thickness less than 100 microns and Young's modulus less than 4 GPa can be used to support a panel around its perimeter. Such boundary termination has an effect between that of a free-free edge condition and that of a simply supported edge condition. The lower modal frequencies are shifted higher in frequency by this termination compared to the modal frequencies for the free-free condition. An embodiment is described in a later section which uses this method of edge termination.

Effect of Different Edge Conditions on Beam Short Edge Conditions

The majority of panel modes for a beam of aspect ratio greater than 5:1 are parallel to the long dimension. For the (0,n) modes in the beam, the edge conditions at the short ends do not have a significant effect while the % change in frequency for the (1,n) modal frequencies will be greater. Nevertheless, the interleaving of these two sets of modes is important to the low frequency performance.

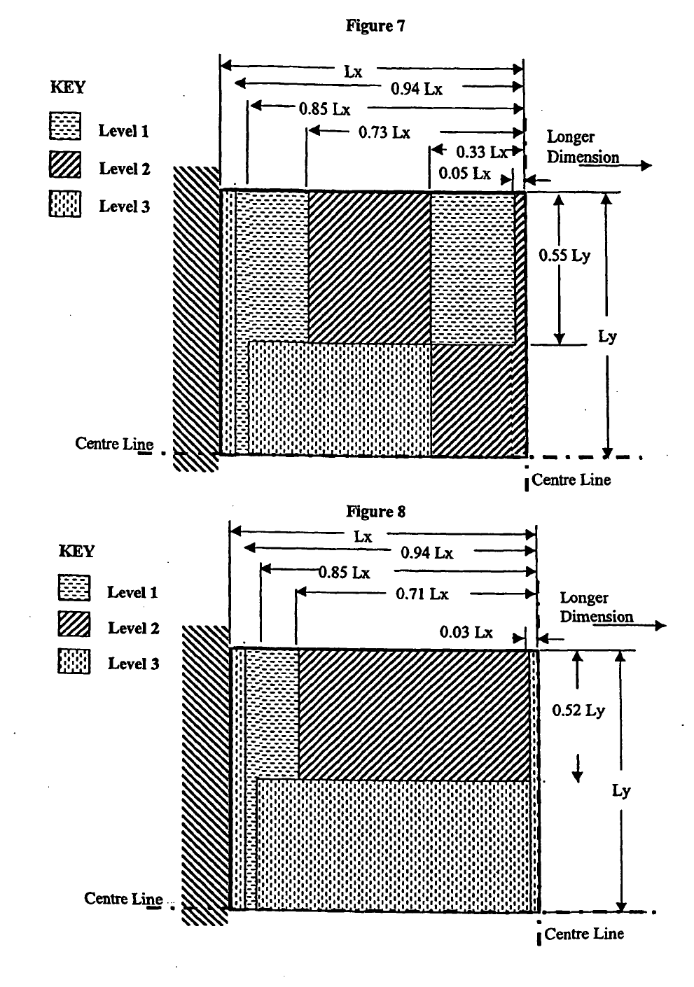

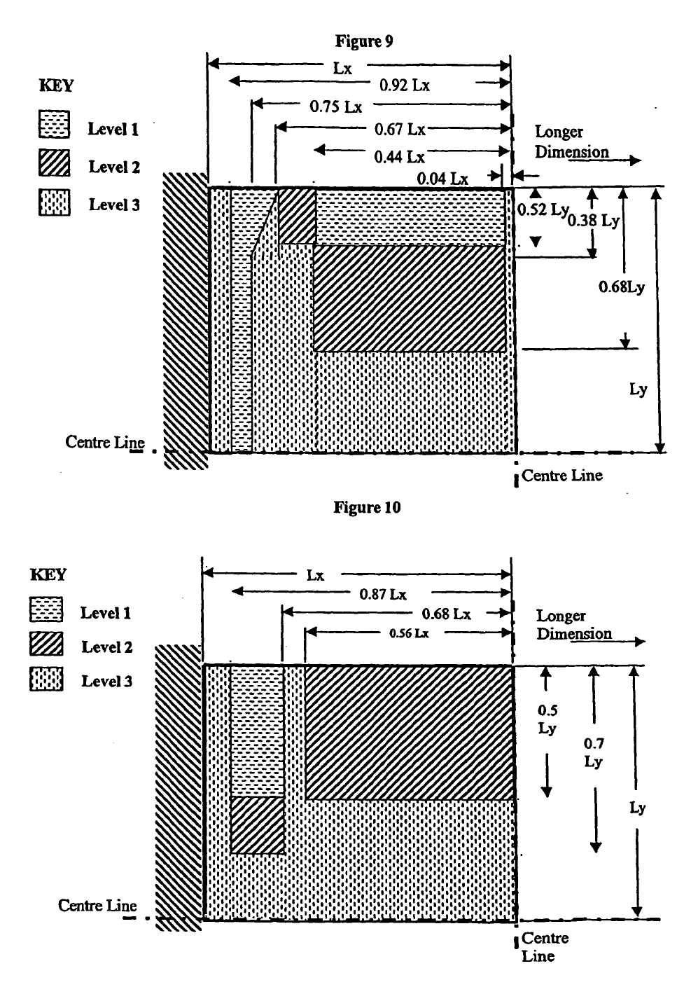

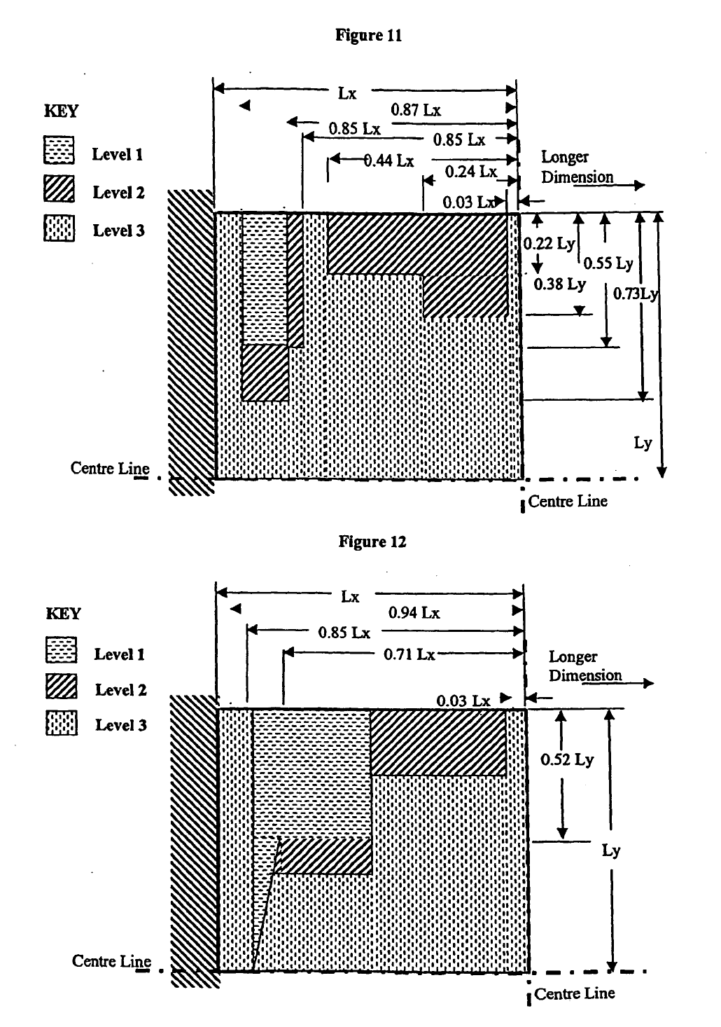

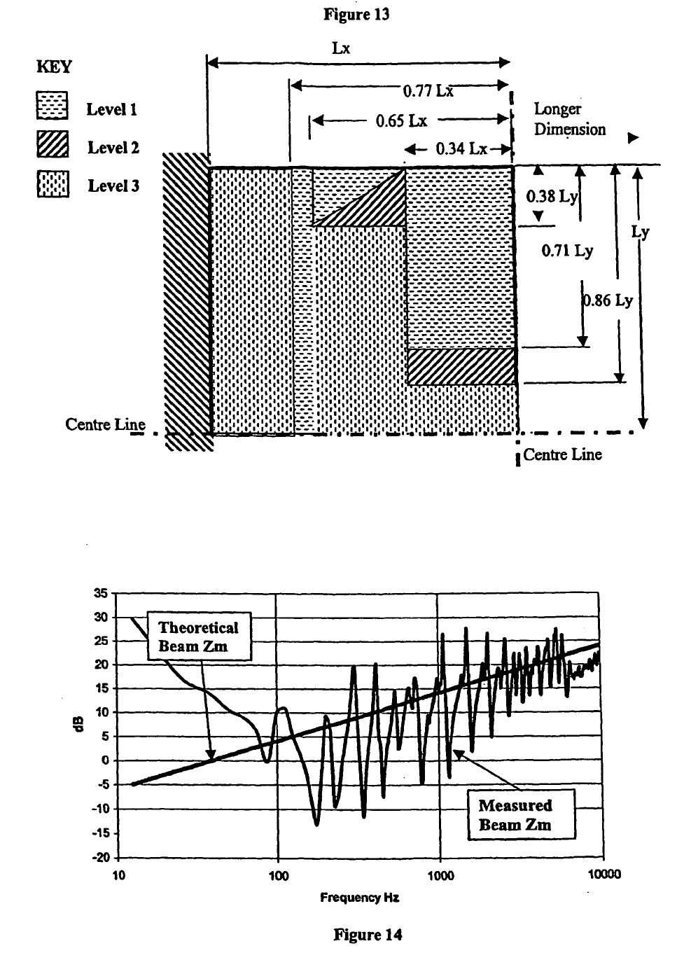

Clearly by simply supporting or clamping the short ends of the beam, the drivemaps will be altered when compared to the free-free case. FIGS. 6 to 9 show the cases when the long edges are kept free whilst the short ends are simply supported for the same range of aspect ratios as detailed in the previous section. FIGS. 10 to 13 show the cases when the long edges are kept free whilst the short ends are clamped for a range of aspect ratios.

For all the drivemaps shown in FIGS. 6 to 13, there is an area directly next to the clamped or simply supported edge which is clearly unsuitable as a drive position due to its proximity to a fixed edge. Comparing the same aspect ratio range for the clamped or simply supported edge conditions shown in FIGS. 6 to 13, there are clearly some common features.

The use of non-symmetrical edge conditions for a beam can also be used to change the acoustic performance of a high aspect ratio loudspeaker. By using differing edge conditions, a non-symmetrical modal system may be created. The resulting drivemaps for this system will also show a non-symmetric pattern. From FIGS. 2, 3, 6 and 10 which relate to the same range of aspect ratios but with free, simply supported and clamped edge conditions at the short ends, it is clear that the central axis parallel to the long dimension is not a Level 1 region. However, if a compliant edge termination were applied to one side of the system, the non-symmetry of the drivemap would result in the central axis now becoming an improved drive position for this loudspeaker. The properties of the two opposing sides of the panel would have to be tailored such that the shift in modal distribution is accounted for or the low frequency performance may be affected.

Long Edge Conditions

Either simply supported or clamped edges along the long sides of the beam will have a deleterious effect upon the modal frequencies. The modes will be shifted to higher frequencies resulting in limited low frequency performance. However, a very compliant foam suspension or a compliant tape/film will allow some displacement at the long edge and can be applied to a beam along its long dimensions without significantly compromising the bandwidth of the speaker. As mentioned previously, this also helps isolate the rear radiation from the front radiation.

An embodiment of using a compliant edge condition on a high aspect ratio panel is considered in the Embodiments Section below.

Energy Absorption at Edges

The edge termination of a beam also has a significant energy absorption capability which can also be used to affect the modality or modal density of a system. Soft foams or compliant tapes/films placed around a beam can be used to absorb energy at a specific frequency and thereby affect the reflected energy from the boundary. These forms of edge termination have an associated stiffness, mass and damping (resistance) which will affect the modal frequencies of the system. This can be modelled via analysis of the mechanical impedance at the edge.

Mechanical Impedance of Beams

For a thin beam, the complex mechanical impedance is defined thus (pg 317, ‘Structure-Borne Sound, ‘Kramer,Heckl and Ungar’)
Zₘ=2 m′ c_{B} (1+j) (11)
where m′ mass per unit length of beam (kg m⁻¹)
c_{B} bending wave velocity (m s⁻¹)

The modulus of the mechanical impedance is therefore:
|Zₘ|=2\sqrt{2}m′c_{B} (12)

It can be seen from equations (11) and (12) that the mechanical impedance of a beam rises as a function of the square root ofω. This affects the impedance which the exciter experiences at its drivepoint.

In order to analyse the relevant exciter/beam parameters when a beam is attached to an exciter, a specific example of a beam (600 mm×33 mm) of Acoustic 88-2 mm (paper skins on paper honeycomb) with an NEC 13 mm electrodynamic exciter is considered. FIG. 14 shows the measured beam impedance in dB versus frequency in Hz.

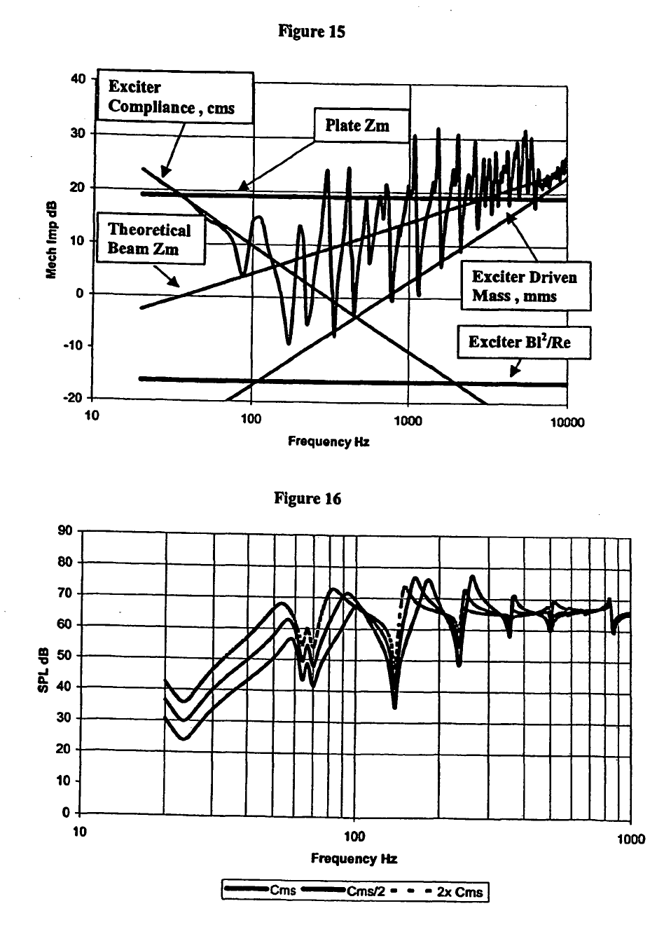

From FIG. 14, it is clear that at low frequencies the exciter will see a lower impedance than at high frequencies. In order to analyse the effect of the exciter parameters on the resulting acoustic response, some of the basic exciter parameters can be plotted directly over FIG. 14 as shown in FIG. 15.

FIG. 15 shows the measured mechanical impedance of this beam and it compares very well with the theoretical analysis shown as a line. The plate Zm is plotted as a constant value and the measurement tends to this limit at high frequency. However, it is worth noting that the measured beam Zm is higher than theoretical plate Zm due to the localised stiffening effect of the voice coil on the exciter. This leads to an increase in the measured Zm as shown in FIG. 15.

Exciter Compliance, Cms

The compliance (exciter suspension) for the exciter is also plotted in FIG. 15. Its gradient matches the slope of the measurement of the mechanical impedance at low frequencies.

FIG. 16 shows a simulation of the effect of changing exciter compliance on the on-axis acoustic pressure for the beam-exciter combination shown in FIG. 15. For the first four modes in the beam, changing the exciter suspension compliance has had a large effect upon the modal frequency and amplitude. Increasing the exciter compliance i.e. making it less stiff, has resulted in shifting the modes down in frequency but increased their amplitude. Conversely, decreasing the exciter suspension compliance results in a decrease in amplitude and increase in modal frequency. This effect of changing modal frequency via compliance modifications is useful in the frequency range from 50 Hz to approx. 300 Hz. From FIG. 16, it is clear that the suspension compliance becomes less significant at higher frequency as the beam impedance increases.

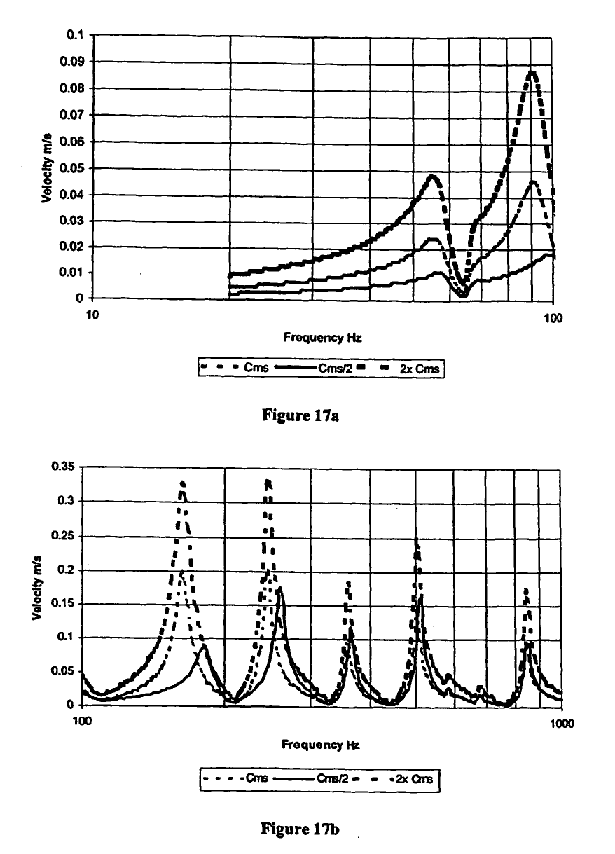

FIGS. 17a and 17b show the same experimental set-up but this time measuring the drivepoint velocity at the exciter between 10-100 Hz and 100 Hz-1 kHz, respectively. This reflects the same trends shown in FIG. 16. The modal frequencies below 500 Hz are significantly affected by the changes in exciter compliance.

Exciter Suspended Mass, Mms

The mass of the exciter will determine the frequency at which the frequency response of the system begins to ‘roll off’. For the same panel area, a beam will have a lower roll-off frequency than a panel with the same area.

Exciter Position

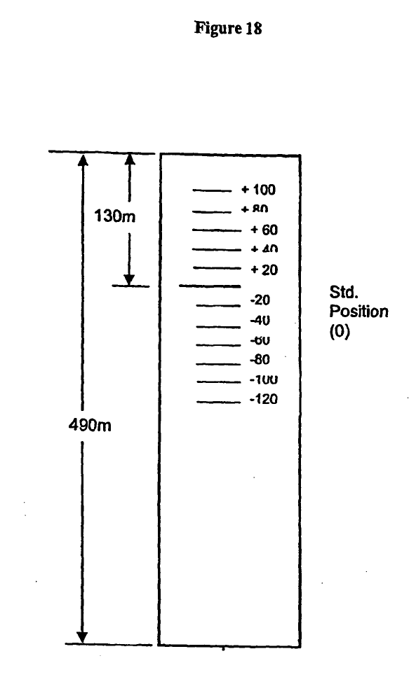

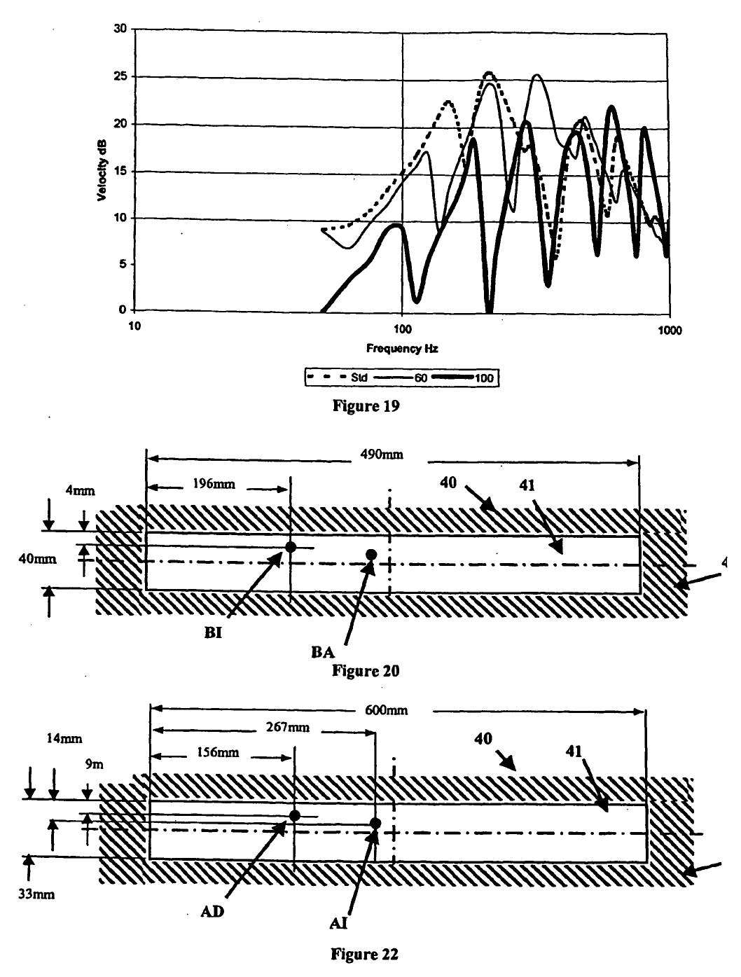

When positioning an exciter on a simple plate, these two components can be viewed as discrete and the interaction between the two has a minimal effect upon the modal frequency. However, for a beam, the lower mechanical impedance at low frequencies results in increased interaction with the low frequency modes. FIG. 18 shows a diagram of beam B with a range of different exciter positions along the length of the beam. FIG. 19 shows the velocity measured at the drivepoint for three of these positions. Clearly, the position of the exciter has an effect on the low frequency modes in the beam.

In summary, FIG. 15 indicates that the exciter parameters at low frequency have a greater effect upon the mechanical behaviour of a beam than for a plate.

### EXAMPLES

In order to illustrate the principle of this invention a number of specific embodiments will now be considered which illustrate features of the invention. The following figures show the design/set-up of these embodiments and their acoustic response.

### EMBODIMENT 1

FIG. 20 illustrates a first embodiment of loudspeaker (40) showing the advantage of using the drivemaps to determine the optimal exciter position for interleaving the low frequency modes of the panel.

A beam-like panel (41) consisting of Acoustic 88-2 mm with the stiffer direction of the material orientated parallel to the longer dimension, of dimensions 490 mm×40 mm (aspect ratio of 12.25:1), is simply supported at the short ends by adhesively bonding the panel ends to a rigid frame (42). The long edges of the beam are supported via a single strip of compliant self-adhesive PVC bonded rigidly to the frame and the panel material itself. A single moving coil vibration exciter was adhesively bonded to the panel at one of the positions BA and BI, with the back of the exciter i.e. its magnet assembly, rigidly grounded to a section of aluminium (not shown) fixed to the frame (42).

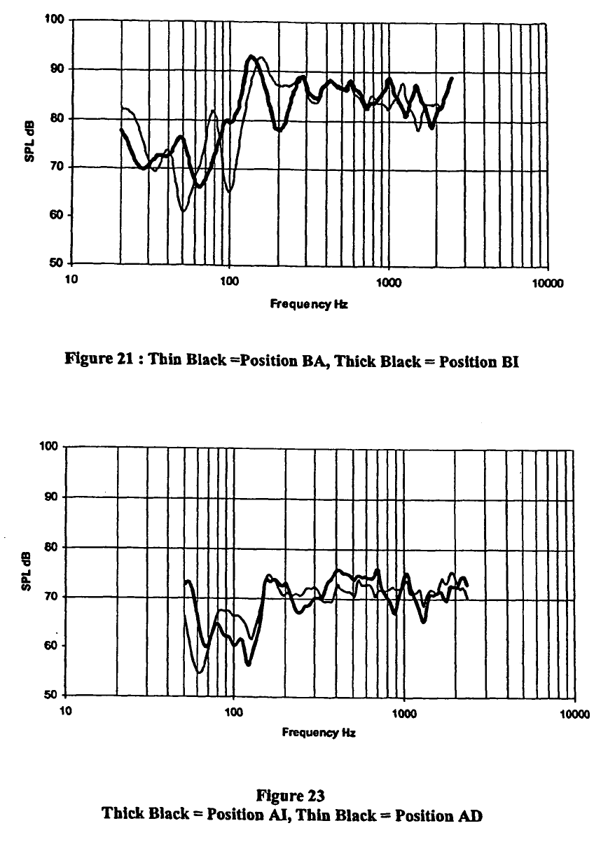

The exciter positions were selected in accordance with the drivemap shown in FIG. 3. Position BI is located in a Level 2 region whilst position BA is located in a Level 1 region as shown in FIG. 3. The acoustic output of this loudspeaker is shown in FIG. 21 for the two exciter regions. For position BA, the acoustic output is smoother between 150 Hz to 2 kHz and there is no suck-out at approximately 200 Hz as there is for the acoustic output for position BI. Although the modal smoothness is improved for position BA, the low frequency limit for BI is lower in frequency. As mentioned previously, this is a consequence of positioning the exciter according to modal density or smoothness rather than bandwidth. The designer may chose a preferred balance of these factors.

### EMBODIMENT 2

FIG. 22 is a second embodiment of loudspeaker (40) which illustrates the advantage of using the drivemaps to determine the good exciter position for interleaving the low frequency modes of the panel.

A beam-like panel (41) consisting of Acoustic 88-2 mm with the stiffer direction of the material orientated parallel to the longer dimension, of dimensions 600 mm×33 mm (aspect ratio of 18.2:1 ), with all edges in the free condition set up in a baffle (43) of size 800 mm×800 mm. The front surface of the beam is positioned level or ‘flush’ with the front surface of the baffle. A 1 m gap between the panel edge and the baffle is maintained around the full perimeter of the beam. A single moving coil vibration exciter was adhesively bonded to the panel at one of the two positions, AD and AI, shown in FIG. 22 and with the back of the exciter i.e. its magnet assembly, rigidly grounded to a section of aluminium, not shown, fixed to the baffle (43). This exciter position was selected according to the drivemap given in FIG. 2. Position AD on FIG. 2 shows this exciter position as being located within a Level 1 region whilst Position Al on FIG. 2 is located within a Level 2 region. This drivemap relates to panels of this specific aspect ratio under free-free conditions.

The on-axis acoustic pressure for this loudspeaker set-up was carried out under semi-anechoic conditions and this measurement is shown in FIG. 23. For position AD, the acoustic response is smooth and flat from 150 Hz to 2 kHz when compared to the acoustic response for position AI. The low frequency limit is very similar for both panels.

### EMBODIMENT 3

FIG. 24 illustrates a third embodiment of loudspeaker (40) which shows the advantage of using the drivemaps for locating the suspension positions in order to minimise their effect on the modal distribution at low frequencies.

This embodiment consists of a beam (41) of Acoustic 88-2 mm (dimensions 490 mm×40 mm) with all edges in the free condition. Two pieces of compliant foam (44) (size 10 mm×5 mm×5 mm) of PVC are positioned on the same side of the beam as the exciter, the position of these foam suspensions being derived from the drivemap (FIG. 6) so that the suspensions were located in a Level 3 region on the panel. In this way, the effect of the suspension on the low frequency modes of the system should be minimised. A 19 mm electrodynamic exciter was positioned at AD and the on-axis acoustic pressure measured for this system with and without the foam suspensions. The foam suspensions were bonded to the rigid supporting frame (42) and the exciter was also grounded to the rigid support frame. The acoustic measurements with and without the foam suspensions are shown in FIG. 25.

For the free case, the acoustic response is smooth between 200 Hz to 2 kHz as would be expected for an exciter positioned at AD (Level 1 region). The addition of foam suspension pads to the system has not significantly changed this modal distribution between this frequency range. Only the low frequency mode which occurred at 110 Hz in the free case has been shifted up in frequency so that it interleaves more closely with the next mode. Therefore, the addition of the foam suspension has not affected the frequency response adversely in this case by following the guidelines provided by the drivemaps.

### EMBODIMENT 4

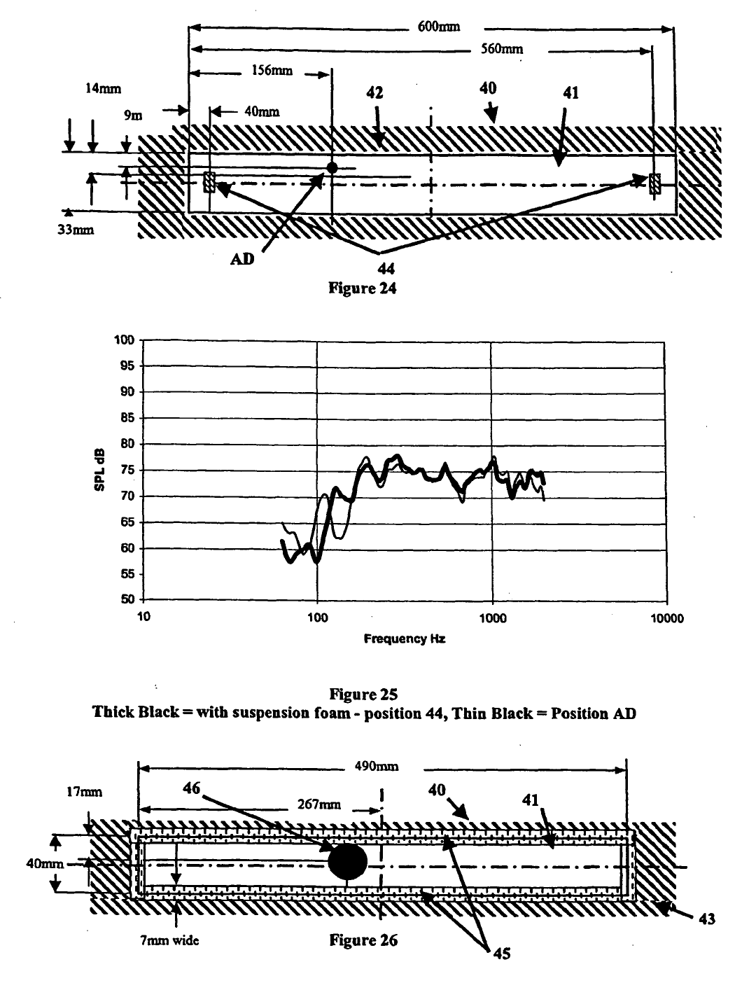

FIG. 26 is a fourth embodiment of loudspeaker (40) showing the acoustic properties of a system with a continuous edge termination (45) placed around the whole perimeter of the beam-like panel (41).

This embodiment shows the effects of using a compliant edge termination (45) on the acoustic response for a high aspect ratio panel. In this case, a panel of aspect ratio 12.25:1 (490 mm×40 mm) driven using a 25 mm diameter electrodynamic exciter (46) is set up with all its edges free. The exciter is positioned in a Level 2 position as considered by use of the drivemap of FIG. 6. As previously the system is set up in a baffle (43) of size 800 mm×800 mm with the panel front flush with the baffle surface. The exciter was rigidly grounded to the frame (42) as before.

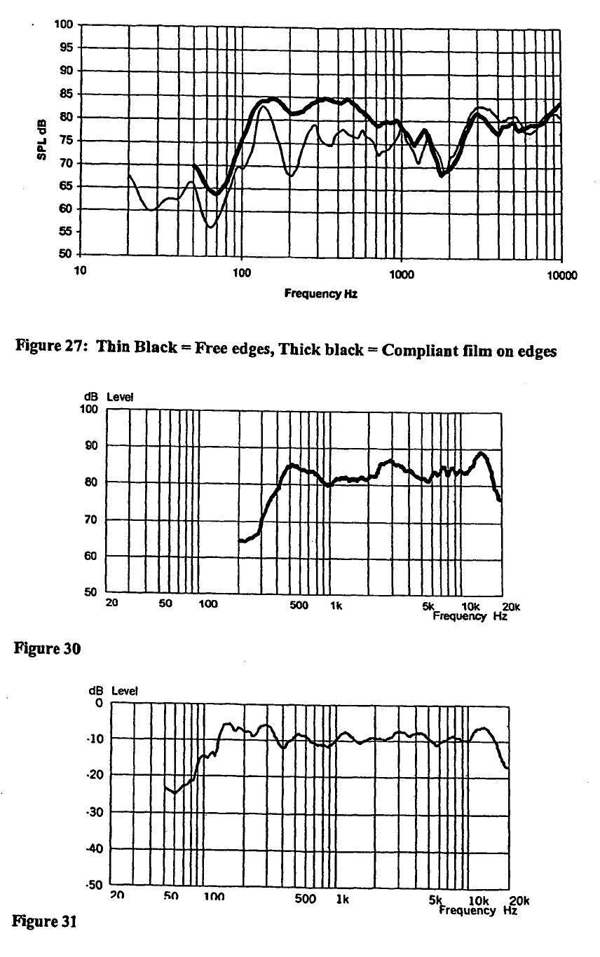

The on-axis acoustic pressure was measured for this system and this is shown in FIG. 27. The ‘suck-out’ at approximately 2 kHz is a diffraction effect and is partially due to front-to-rear cancellation. The frequency response is not as densely modal as it could be if the exciter had been placed in a Level 1 region on the panel surface rather than a Level 2 region. This has resulted in a poor modal density at low frequency.

The system was then modified by the addition of a compliant edge termination. This consisted of a 50 microns thick compliant thermoplastic film which was adhesively bonded to the panel and baffle via a 25 microns thick self-adhesive tape around the full perimeter of the panel. The density of this film is approx. 110 kg m⁻³ and the tensile Young's modulus is approx. 0.2-0.3 Gpa. No tension was applied to this film so that displacement of the panel edge was possible.

FIG. 27 shows the effect of this edge termination on the acoustic response of this system. The high frequency response has not been greatly affected but the low frequency response has changed considerably. From 100 Hz to 1 kHz, the output has been increased with the degree of change greatest at low frequencies. The individual modes of the panel at low frequencies have been broadened such that the frequency response now appears more smooth. The addition of the suspension material has added a degree of damping to the system which has broadened these modal frequencies.

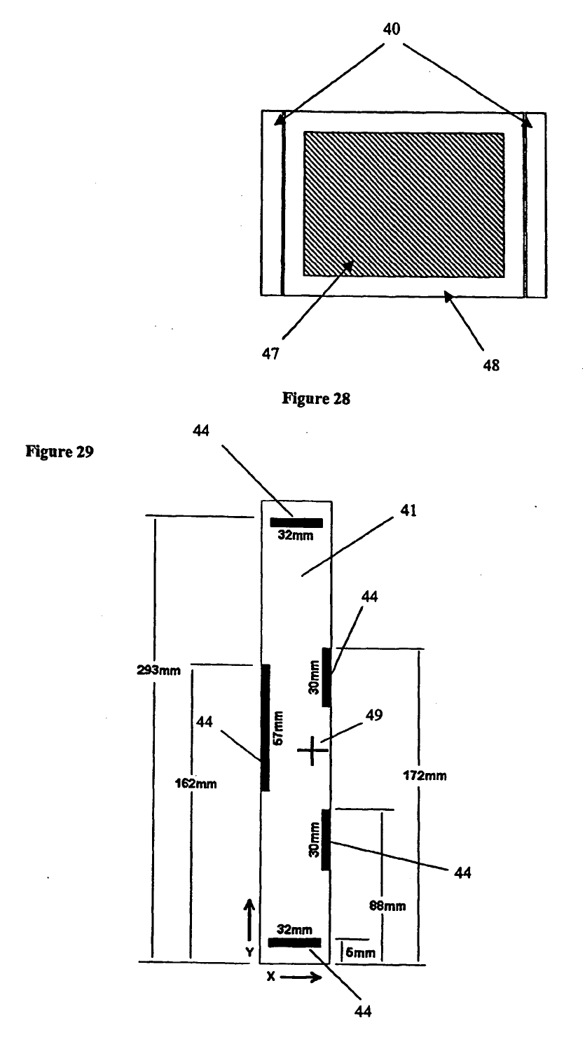

FIGS. 28 to 31 illustrate a practical embodiment of a very high aspect ratio panel loudspeaker (40) intended as an-add on loudspeaker for a flat panel monitor or display screen (47), which may be a liquid crystal display (LCD) in a frame or casing (48). The requirements of this application from an aesthetic point of view make the high aspect ratio solution advantageous over lower aspect ratio distributed mode loudspeakers or conventional pistonic cone speakers.

The speaker specification is as follows:

| | |
|---|---|
| Panel Dimensions: | 298 mm × 34 mm × 2 mm |
| Panel Material: | Honipan HHM-RTY-2 mm - i.e. |
| | randomly spun polyethylene (Tyvek |
| | (TM)) skins on PMI |
| | (polymethylacrylimide) foam |
| | (Rohacell (TM)) core |
| Panel Properties | Bending stiffness (B) = 0.40 Nm |
| | Areal density ( ) = 0.33 Kgm⁻³ |
| Exciter: | 19 mmØ, Nominally 8Ω, Tianle. |
| Panel Mounting Foam: | PVC soft foam double sided (Miers |
| | 101A) tape 5 mm thick - Layer of |
| | double sided acrylic adhesive |
| | (Tessa (TM)) tape both sides |
| Exciter Grounding: | Magnet Cup Grounded to Chassis |
| | via 2 × layers of 0.8 mm closed |
| | cell polyethylene foam (MACTAC |
| | (TM)) with double sided adhesive |
| | tape |
| Exciter/Panel Bond: | 3M double sided adhesive die-cut |
| | disc. Ext Ø: 30 mm, Int Ø: 20 mm |
| | (3M - 9473 adhesive, i.e. double |
| | side acrylic adhesive) |
| Exciter Position: | 12 mm, 124 mm relative to the lower |
| | left-hand corner, viewed from the |
| | rear. |

FIG. 29 is a general view of a flat-panel display screen (47) with beam-like panel-form speakers (40) on opposite sides. FIG. 29 shows the speaker panel (41) from the rear side, indicating both the exciter position (49) and the location of the suspension areas (44).

The choice of suspension positions was determined by two parameters. Firstly two 32 mm long foam supports (44) at each end of the panel were located in the vicinity of the nodal lines in this area in order to provide a good approximation to a free panel over most of the frequency range. This allows the use of the drive maps generated for free boundary conditions. Secondly the suspensions along each of the longer sides of the panel were chosen to control the low frequency excursions of the panel. This also has the benefit of providing some static structural stability to the panel, increasing the robustness of the device.

The panel is mounted in a frame (not shown) for attachment to the casing (48) of the LCD monitor (47). The enclosure that this frame presents to the panel is of a semi-open back type. This results in good low frequency performance, preventing some of the sharp drop off in low frequency performance that can be experiences with a fully sealed loudspeaker unit.

The performance of the speaker is shown in FIG. 30 which shows the spatial average of the sound pressure level 0.5 m from the monitor screen (47) when driven at 1 S input. The trace has been smoothed into third octaves.

The sound pressure level (SPL) produced by the two satellite speakers (40) can be also augmented by a single woofer (not shown) to provide low frequency output. This is combined with active equalisation of both the high aspect ratio panel output and the crossover to the woofer. FIG. 31 shows the final frequency response achieved, demonstrating the smoothness and high quality of the end result. The data has been third octave smoothed and is presented relative to an arbitrary dB reference level.

The key features of the embodiment include:
High aspect ratio panel 1:8.8
Exciter positioned off the centre axis of symmetry to excite both the (0,n) and (1,n) modes.

Free End Boundary Conditions

Exciter placed close to level 1 area as shown in FIG. 4 (7:1>AR>12:1) given the mechanical constraints of the application, which is limited by the size of the exciter used. The position of the exciter corresponds to 0.17Lx, 0.71Ly, with the same location convention as used in the drive map diagrams. Additional foam supports to control low frequency excursion and provide structural stability.

1. A resonant bending wave loudspeaker comprising a panel-form acoustic radiator in the form of a beam and a vibration transducer mounted to the beam at a position to apply bending wave energy thereto to enable low frequency modes to be excited in the radiator both lengthwise of the radiator and crosswise of the radiator, and means mounting the radiator to permit the excitation of low frequency lengthwise and crosswise modes therein, and wherein the beam has an aspect ratio of at least 5:1 and less than 50:1.

2. A loudspeaker according to claim 1, wherein the beam is of a material with an anisotropy of bending stiffness ratio in the x and y directions of between 5:1 to 1:5.

3. A loudspeaker according to claim 1 or claim 2, wherein the physical parameters of the beam and the position of the transducer on the beam are such that the lengthwise and crosswise modes in the beam are interleaved in frequency to create a smooth low frequency response.

4. A loudspeaker according to claim 3, wherein the mounting means restrains the short edges of the beam.

5. A loudspeaker according to claim 4, wherein the mounting means is attached to the beam in regions where it has minimal effect upon the modal distribution of the radiator.

6. A loudspeaker according to claim 3, wherein the mounting means provides non-symmetrical edge or boundary conditions for the opposing sides of the beam.

7. A loudspeaker according to claim 6, wherein the mounting means comprises a suspension of compliant tape or film or a soft low modulus foam applied to the long dimensions of the beam to damp the low frequency modes to smooth the frequency response.

8. A loudspeaker according to claim 1 or claim 2, wherein, the vibration transducer is electrodynamic and wherein the mechanical impedance of the beam at low frequencies interacts with the exciter parameters, thereby creating a loudspeaker where the frequency of the modes in the low frequency region is altered by the presence of the exciter.

9. A method of designing a resonant bending wave loudspeaker comprising a panel-form acoustic radiator in the form of a beam having an aspect ratio of at least 5:1 and less than 50:1, and a vibration transducer mounted to the beam at a position to apply bending wave energy thereto to enable low frequency modes to be excited in the radiator both lengthwise of the radiator and crosswise of the radiator the method comprising determining a position for locating the vibration transducer on the beam by deriving a model of the resonant modes in the beam from physical parameters of the beam, using the model to calculate the mechanical input power from the transducer to the beam as a function of frequency, calculating a measure of smoothness of the mechanical input power and selecting the position of the vibration transducer which has a desired value of the measure of smoothness.

10. A method according to claim 9, wherein the measure of smoothness of the mechanical input power is a measure of the mean square deviation of the input power from a constant value of the average input power.

11. A method according to claim 9 or claim 10, wherein the mechanical input power is calculated when applying a constant point force to a single point on the beam.

12. A method according to claim 11, comprising selecting the position of the vibration transducer which optimises the measure of smoothness.

13. A method according to claim 9 or claim 10, comprising selecting the position of the vibration transducer which optimises the measure of smoothness.

14. A loudspeaker according to claim 1 or claim 2, wherein the mounting means restrains the short edges of the beam.

15. A loudspeaker according to claim 14, wherein the mounting means is attached to the beam in regions where it has minimal effect upon the modal distribution of the radiator.

16. A loudspeaker according to claim 1 or claim 2, wherein the mounting means provides non-symmetrical edge or boundary conditions for the opposing sides of the beam.

17. A loudspeaker according to claim 16, wherein the mounting means comprises a suspension of compliant tape or film or a soft low modulus foam applied to the long dimensions of the beam to damp the low frequency modes to smooth the frequency response.
